(19) United States
(12) Patent Application Publication
(10) Pub. No.: US 2026/0304056 A1
(43) Pub. Date: Oct. 1, 2026

(54) METHOD FOR ADJUSTING THE SPREAD OF A SOUND OBJECT AND CORRESPONDING MIXING TOOL

(71) Applicant: Areal BV, Wuustwezel (BE)

(72) Inventors: Pieter Doms, Wuustwezel (BE); Arno Voortman, Overmere (BE)

(21) Appl. No.: 19/475,977

(22) PCT Filed: Apr. 16, 2024
(86) PCT No.: PCT/EP2024/060255

§ 371 Date: Oct. 16, 2025

(30) Foreign Application Priority Data
Apr. 17, 2023 (BE) 2023/5286

(51) Int. Cl. H04S 7/00

(52) U.S. Cl. CPC H04S 7/30; H04S 2400/11; H04S 2400/13

(57) ABSTRACT

The invention relates to mixing audio sounds in a 3D environment, and to computer-implemented audio signal processing methods for regulating the emphasis on sound objects in a 3D environment.

### FIELD OF THE INVENTION

The invention relates to mixing audio sounds in a 3D environment, and to computer-implemented audio signal processing methods for regulating the emphasis on sound objects in a 3D environment.

### BACKGROUND

Stereo is a 2-dimensional (2D) audio experience, where the user typically receives sounds from the lefthand side, righthand side, front, and back.

In a spatial or 3D sound environment, on the other hand, audio sounds are received from 3 dimensions, typically including left, right, front, back, above, and below. 3D audio delivers a richer, higher quality audio experience which is more natural to users, since it more closely mimics how people listen to sounds in real life. With 3D audio, one can hear multiple sounds or voices occurring at the same time, allowing the listener to pinpoint the direction and distance of the different sound sources or sound objects. 3D audio is typically used in Virtual Reality (VR) projects and games, as well as in some movies having special effects. With 3D audio, a more immersive experience may be created for the listener compared to stereo audio.

When making and mixing music, movies, video games, or other types of audio pieces in stereo, it was necessary to give every part of the music its specific place in the mix. In stereo, there is a lot less space available for each of the audio pieces or objects to be placed. To properly mix all audio objects in 2D, a dynamic compressor could be used. A dynamic compressor as we know it today is a device which limits the dynamic range of a specific audio object in the mix. The device operates by attenuating the audio gain once the sound crosses its predefined threshold. This however may result in an unnatural sound experience.

When mixing immersive audio in a 3D environment compared to a 2D environment, there is much more space to place all the pieces of sound that will make, e.g., the total piece of music. Therefore, the use for a dynamic compressor becomes less important. When moving from stereo audio to immersive 3D audio, the amount of space available may increase to a point where it is possible that there is too much space available for the pieces of sound that will make the music piece. In this case, a listener can experience the music as if the different pieces of sound are coming from different directions in the room and not forming a whole.

Nowadays, 3D mixing tools provide the possibility for each piece of sound or audio object to be placed in a room as individual objects. The spread of the object may also be set-up to be wide (or broad), aiming at closing all the spatial gaps which are experienced by the listener as voids in the sound, thus allowing the objects to work together and improving the sound experience for the listener. Although this type of mixing will improve the global experience for the listener, it will also reduce the detail in an immersive mix which may result in losing the effect of 3D audio. A global dull sound may be experienced rather than a vivid sound experience with objects which can be pinpointed in a direction and at a specific distance.

Previous mixing tools in 2D audio and 3D audio would typically involve amending the volume of a specific object if more or less focus was needed for this audio object. However, increasing the focus by raising the volume would typically also raise the decibels up to a level above the allowed level. Raising the volume would also not create the desired effect. In an immersive mix, the challenge is to blend all the objects together. Raising the level to raise focus would decompose the immersive mix, isolating the object from the mix instead of raising the focus.

US 2017/325045 A1 discloses an audio signal processing device for performing binaural rendering on an input audio signal. The audio signal processing device includes a reception unit configured to receive the input audio signal, a binaural renderer configured to generate a 2-channel audio by performing binaural rendering on the input audio signal, and an output unit configured to output the 2-channel audio. The binaural renderer performs binaural rendering on the input audio signal based on a distance from a listener to a sound source corresponding to the input audio signal and a size of an object simulated by the sound source.

US 2021/076153 A1 discloses an apparatus comprising: means for causing selection of spatial audio content in dependence upon a position of a user in a virtual space; means for causing rendering, for consumption by the user, of the selected spatial audio content including a first spatial audio content; means for causing, after user consumption of the first spatial audio content, recording of data relating to the first spatial audio content; means for using, at a later time, the recorded data to detect a new event relating to the first spatial audio content, the new event comprises that the first spatial audio content has been adapted for which a new spatial content is created, for example in the form of a limited preview; and means for providing a user-selectable option to enable rendering, for consumption by the user, of the first spatial audio content by rendering a simplified sound object representative, which can be a downmix or clustered audio objects.

A new challenge is therefore to find a way to still fill all the spatial gaps so that all pieces of sound work together to create one whole piece of music, which is harmonized and which comes across as a natural sound, while still being able to emphasise specific sound objects and allowing them to be more present or less obvious.

In the face of all these phenomena, there is a need for a mixing tool which can act dynamically in cooperation with the dynamic properties of an object while maintaining a high quality 3D audio experience.

Therefore, there is a need for methods to properly spread out all the objects to fill the spatial gaps in a 3D environment, while allowing for a more efficient emphasis on a particular object when a threshold value is reached or exceeded.

There is also a need for methods that prevent or reduce hearing fatigue. Dynamic compressors (when used intensely) could speed up the hearing fatigue, since dynamic compressors are being used to play as auditory loud as possible while staying between the predefined limits.

### SUMMARY OF THE INVENTION

The inventors have surprisingly found that one or more of these problems can be solved by the present invention and (preferred) embodiments thereof. The present invention allows to act dynamically in cooperation with the dynamic properties of an object while maintaining a high quality 3D audio experience. The present invention also fills the spatial gaps in a 3D environment, while allowing for a more efficient emphasis on a particular object. By removing the need for dynamic compressors and using the space to create or lose focus, the present invention helps to prevent hearing fatigue, and, on the long term, prevents hearing damage.

According to a first aspect, the invention relates to a computer-implemented audio signal processing method for regulating the emphasis on sound objects in a 3D environment. The sound objects are typically spaced in the available 3D environment. The sound objects are preferably spread such that the spatial gaps in between the objects in the 3D environment are completely or partially filled, preferably completely filled. The method preferably comprises one or more, preferably all, of the steps of:
setting a threshold level for a dynamic property, preferably the gain, of a first object; and,
adjusting the spread of the first object in the 3D environment when the threshold level of the dynamic property, preferably the gain, of the first object is reached or exceeded.

In some preferred embodiments, the method further comprises the steps of:
setting a threshold level for a dynamic property, preferably the gain, of one or more additional objects; and,
adjusting the spread of the one or more additional objects in the 3D environment when the threshold level of the dynamic property, preferably the gain, of the corresponding object is reached or exceeded.

In some preferred embodiments, the step of adjusting the spread of the first object (and/or of the one or more additional objects) comprises narrowing the spread of said object in the 3D environment.

In some preferred embodiments, the step of adjusting the spread of the first object (and/or of the one or more additional objects) comprises widening the spread of said object in the 3D environment. By doing so, there will be less emphasis on the first object (and/or on the one or more additional objects) which were adjusted in the 3D environment.

In some preferred embodiments, narrowing the spread of the first object will correspond to widening the spread of one or more additional objects. In some preferred embodiments, widening the spread of the first object will correspond to narrowing the spread of one or more additional objects.

In some preferred embodiments, the absolute amount of adjustment to the spread of a first object correspond to the absolute amount of adjustment to the spread of at least one additional object. In some preferred embodiments, the relative amount of adjustment to the spread of a first object correspond to the relative amount of adjustment to the spread of at least one additional object.

The adjustment of the spread of a first sound object may result in adjusting the spread of a single second sound object in the opposite direction. Alternatively, the adjustment of the spread of a first sound object may result in adjusting the spread of more than one additional sound objects in the opposite direction. As a further alternative, adjusting the spread of a first and a second sound object in one direction may result in adjusting a third sound object in the opposite direction. As another further alternative, adjusting a combination of multiple sound objects in one direction may result in adjusting another combination of multiple sound objects in the opposite direction.

In some preferred embodiments, narrowing or widening the spread of the first object is defined by a ratio between the amount of level the dynamic property, preferably the gain, generates above the threshold level, preferably expressed in decibels dB, in relation to the amount of spread, preferably expressed in percentage.

In some preferred embodiments, the method further comprises the step of:
adjusting the gain of the first object and/or the one or more additional objects in the 3D environment when the threshold level of the dynamic property, preferably the gain, of the first object is reached or exceeded and/or when the threshold level of the dynamic property, preferably the gain, of the one or more additional objects is reached or exceeded.

In some preferred embodiments, the step of adjusting of the spread starts at the start of the attack zone.

In some preferred embodiments, the step of adjusting the spread only takes place as long as the threshold level of the dynamic property, preferably the gain, of the object is reached or exceeded.

In some preferred embodiments, the step of adjusting the spread comprises the steps of:
once the threshold value is reached or exceeded, adjusting the spread in a first direction to widen or narrow the spread to a desired value;
as long as the threshold value is reached or exceeded, holding the spread at the desired value; and,
once the threshold value is no longer reached nor exceeded, adjusting the spread to the original value.

According to a second aspect, the invention relates to a mixing tool for processing audio signals of sound objects in a 3D environment. The mixing tool preferably comprises:
an input channel for receiving an input signal;
an output channel for transmitting an output signal; and,
a detector configured for receiving the input signal, for determining whether the input signal is equal to or greater than a threshold value, preferably of the gain, and for sending a control signal when the threshold value is reached or exceeded.

The mixing tool preferably further comprises a spatial adjuster, configured for receiving the input signal and adjusting the spread of the input signal on the basis of the control signal sent by the detector, to form an output signal.

In some preferred embodiments, a second control signal is sent out to adjust an additional dynamic property of the input signal when the threshold value is reached or exceeded; preferably wherein the additional dynamic property is selected from gain, position, reverb, and/or combinations thereof; preferably wherein the additional dynamic property is gain.

In some preferred embodiments, the spatial adjuster comprises a spatial compressor to narrow the spread of the input signal when the threshold value is reached or exceeded; and/or the spatial adjuster comprises a spatial expander to widen the spread of the input signal when the threshold value is reached or exceeded.

In some preferred embodiments, the mixing tool according to the second aspect, and (preferred) embodiments thereof, is configured to perform the method according to the first aspect, and (preferred) embodiments thereof.

According to a third aspect, the invention relates to use of the method according to the first aspect, and (preferred) embodiments thereof, and/or of the mixing tool according to the second aspect, and (preferred) embodiments thereof, preferably in a live setting. (Preferred) embodiments of the first aspect are also (preferred) embodiments of the second or third aspect, and vice versa.

### BRIEF DESCRIPTION OF THE FIGURES

FIG. 1 illustrates classical gain control in a stereo (2D) environment.

FIG. 2 illustrates the effect of broadening (or widening) the spread of an audio object in a 3D environment.

FIG. 3 illustrates spatial compression and spatial expansion when a threshold is exceeded, according to an embodiment of the invention.

FIG. 4 illustrates a schematic representation of a dynamic feedback or feedforward spatial adjuster (spatial compressor or spatial expander), according to an embodiment of the invention.

FIG. 5 illustrates a schematic representation of a spatial adjuster (spatial compressor or spatial expander) which also allows for gain adjustment, according to an embodiment of the invention.

### DETAILED DESCRIPTION OF THE INVENTION

The present invention will be described with respect to particular embodiments; the invention is not limited thereto but only by the claims. Any reference signs in the claims shall not be construed as limiting the scope thereof.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements, or method steps. The terms “comprising”, “comprises” and “comprised of” when referring to recited members, elements or method steps also include embodiments which “consist of” said recited members, elements, or method steps.

Furthermore, the terms first, second, third, and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The term “about” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

The recitation of numerical ranges by endpoints includes all numbers and fractions subsumed within the respective ranges, as well as the recited endpoints. All documents cited in the present specification are hereby incorporated by reference in their entirety. Unless otherwise defined, all terms used in disclosing the invention, including technical and scientific terms have the meaning as commonly understood by one of the ordinary skill in the art to which this invention belongs.

By means of further guidance, definitions for the terms used in the description are included to better appreciate the teaching of the present invention. The terms or definitions used herein are provided solely to aid in the understanding of the invention. Reference throughout this specification to “one embodiment” or “an embodiment” means that a particular feature, structure, or characteristic described in connection with the embodiment is included in at least one embodiment of the present invention.

Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the following claims and description, any of the claimed or described embodiments can be used in any combination.

According to a first aspect, the invention relates to a computer-implemented audio signal processing method for regulating the emphasis on sound objects in a 3D environment. The sound objects are spaced in the available 3D environment. The sound objects are preferably spread such that the spatial gaps in between the objects in the 3D environment are completely or partially filled, preferably completely filled. The method preferably comprises one or more, preferably all, of the steps of:
setting a threshold level for a dynamic property, preferably the gain, of a first object; and,
adjusting the spread of the first object in the 3D environment when the threshold level of the dynamic property, preferably the gain, of the first object is reached or exceeded.

As used herein, the terms “3D environment” or “3D space” are used interchangeably, and refer to an immersive soundscape, as opposed to stereo which has a left-to-right soundscape.

As used herein, the terms “sound object” or “audio object” refer to a discrete audio source that can be positioned and manipulated in 3D space to create a realistic spatialisation of sound. It represents a specific audio element in the virtual environment and may typically be moved, panned, and adjusted independently of other sound elements to produce a realistic and immersive audio experience.

In 3D sound processing, the following terms may be used relating to typically time-dependent variables, herein collectively referred to as “dynamic properties”:
The term “gain” refers to the volume level or amplification of a sound.
The term “reverb” refers to the simulation of the reflection and reverberation of sound in a physical environment.
The term “spread” refers to the width of sound sources in a 3D space, and how far the sound is dispersed from its original location.
The term “position” refers to the location of a sound source in a 3D space, and can be used to create a sense of spatial orientation and movement of sound in a virtual environment.

When a “threshold” value is exceeded, it is referred to as “threshold crossing” or “going over the threshold”. In audio processing, threshold values are used in dynamic range processing tools, such as compressors, to determine the level at which a specific effect should be applied to an audio signal. Preferably, the threshold is related to the gain (volume level) of the sound object. Typical ranges of threshold are −60 dB up to +20dB.

As used herein, the term “dynamic range” refers to the difference between the loudest and softest parts of an audio signal. It is usually measured in decibels (dB) and represents the range between the highest and lowest sound levels in a recording or performance. The dynamic range of an audio object is an important factor that affects the perceived quality and overall impact of the sound, and can be influenced by various factors including recording techniques, mixing, and mastering. A larger dynamic range allows for more detail and nuance in the audio signal, while a smaller dynamic range can make the sound seem more compressed and uniform.

As used herein, the term “dynamic adjuster” refers to an audio processing tool that is used to control the dynamic range of a sound. A dynamic adjuster may comprise a dynamic compressor and/or a dynamic expander. A dynamic compressor typically reduces the dynamic range of a sound by automatically lowering the volume of the loudest parts while leaving the quiet parts unchanged. This helps to even out the volume levels and prevent clipping or distortion, making the sound more consistent and controlled. A dynamic expander adds gain to a signal that reaches the predefined threshold. So an expander adds more dynamic range than originally present in the input signal. This helps to reveal more detail and nuance in the audio signal, making the sound seem more dynamic and expressive.

The step of adjusting the spread according to the present invention, is herein also referred to as a “spatial adjustment”, which may include “spatial compression” and/or “spatial expansion”. The tool used for spatial adjustment may herein be referred to as a “spatial adjuster”. As used herein, the term “spatial adjuster” refers to an audio processing tool that is used according to the invention to control the width of the spread of a sound. A spatial adjuster may comprise a “spatial compressor” and/or a “spatial expander”. A spatial compressor will narrow the width of the spread of a sound object. A spatial expander will broaden (or widen) the width of the spread of a sound object.

As used herein, the term “Lows” refers to the low-frequency range of sound, typically defined as being below around 250 Hz. This frequency range is often responsible for providing depth, weight, and warmth to a sound, and can affect the perceived bass or low-end energy of a sound. As used herein, the term “Mids” refers to the mid-frequency range of sound, typically defined as being between around 250 Hz to 4 kHz. This frequency range is often considered to be the most important in shaping the overall tonality and character of a sound. As used herein, the term “Highs” refers to the high-frequency range of sound, typically defined as being above 4 kHz. This frequency range is often responsible for providing definition, clarity, and brightness to a sound, and can affect the perceived brightness or sharpness of a sound.

In stereo or 2D audio, a dynamic compressor is typically used to give every part of the music its specific place in the mix. A dynamic compressor is a device which limits the dynamic range of a specific piece of the mix. Therefore, the gain of an audio source may be compressed during a specific period of time to balance out too much noise and not enough volume, or vice versa. Gain is the unit of measurement for the loudness of an audio source and is typically measured in decibels (dB).

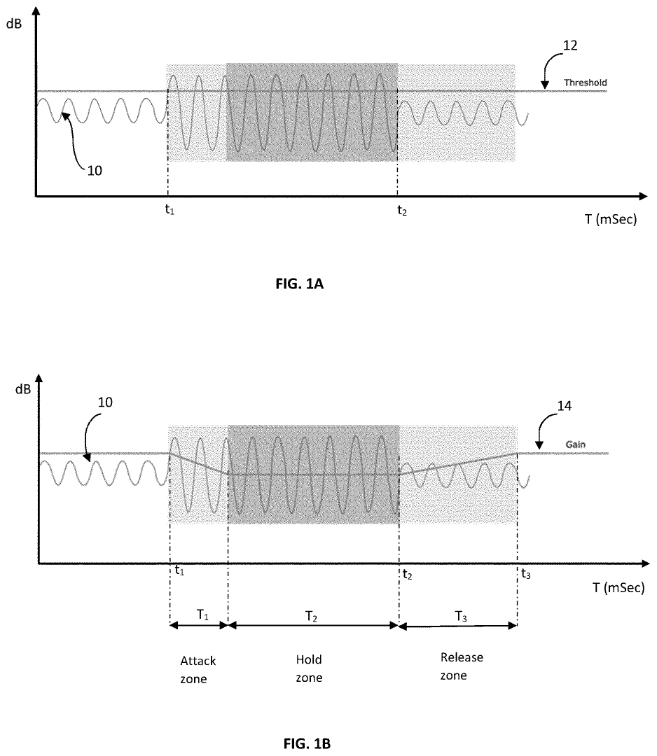

Gain control is illustrated in FIG. 1A, where a specific piece of sound or object 10, such as background noise, is shown in a stereo environment. At a certain point in time t₁, the gain of this specific sound object 10 is increased, for example when the level of a background noise 10 becomes more present, thus increasing the global level of decibel (dB). If the level of dB reaches or exceeds the set threshold level 12, a compressor 20 may operate by attenuating the level of the sound and will decrease the impact of the background noise 10 on the global sound. When the background noise 10 decreases again at time t₂, the compressor 20 may stop the attenuation and the normal level of sound will be attained again.

The effect of the attenuation by the compressor 20 is shown in FIG. 1B. Once the background noise 10 reaches the threshold value 12 at time t₁, the compressor 20 will start to gradually adjust the gain 14 over a first period of time T₁ to a specific level (herein labelled as the attack zone). Once it reaches a desired adjusted level, it will maintain this level of audio gain 14 for a period of time T₂ (herein labelled as the hold zone), until the background noise 10 no longer exceeds the threshold value 12 at time t₂. During a final period T₃ (herein labelled as the release zone), the audio gain 14 will now be allowed to gradually rise again to its original level.

The way the gain 14 is reduced once the sound 10 reaches or exceeds the threshold 12, how fast it is reduced, or how long it holds the attenuation once the sound drops again below the selected threshold, and how it reverts back to the original sound level, are all adjustable parameters known as “attack”, “hold” and “release”. In some embodiments, the attack time is at least 0 ms to at most 150 ms. In some embodiments, the hold time is at least 50 ms to at most 1000 ms. In some embodiments, the release time is at least The slope of the attenuation may be from at least 1.5:1 to infinite:1.

In some preferred embodiments, narrowing or widening the spread of the first object is defined by a ratio between the amount of level the dynamic property generates above the threshold level, preferably expressed in decibels dB, in relation to the amount of spread, preferably expressed in percentage. The ratio may be a variable ratio between the amount of level the input signal generates above the threshold level (expressed in decibels dB) in relation to the amount of spread (or size) expressed in percentage. The ratio of the spatial compressor may be defined in percent ranging from 0 to 100.

The gain control may be performed using a dynamic feedback compressor or a feedforward compressor. Prior art dynamic compressors will typically balance out the different sound objects by reducing the gain spikes in sound objects so that a global sound experience is achieved.

Although existing dynamic compressors and dynamic expanders are typically used with surround sound, a dynamic compressor and/or a dynamic expander can also be used to create a 3D sound experience. However, it has been found that a reduction of the gain will also reduce the detail in an immersive mix, often losing the effect of 3D audio. When increasing the audio gain, this can come across as being too loud, outpowering the remaining sound objects and causing a level of audio gain reaching above the allowed regulatory threshold. Additionally, globally increasing the volume or gain will require more power consumption of the audio installation which may not always be possible when dealing with large sound setups, as may be the case when used during music festivals.

Additionally, the aim in 3D sound experiences, is to be able to experience a more realistic hearing experience due to the possibility to create, e.g., a moving effect of the sound. For instance, a sound may me experienced as being moved from the left side to the right side, as would be the case when an object would be passing behind a person from the left to the right. Increasing the volume of a sound object will not necessarily create this realistic hearing experience.

Further, in 3D environment sound experiences, it is an aim to fill the available 3D space with sound objects such that a listener will experience the sound as if they are standing in the middle of the sound, and not just having a sound originating from one point.

When mixing immersive audio in a 3D environment, there is significantly more room to place all the pieces of sound that will make for example a piece of music compared to the stereo environment. If the same sound objects as in a stereo environment would be placed in a 3D environment, the objects would be placed further apart from each other, thus having a less interfering factor. Therefore, the need of a dynamic compressor to level out specific sound objects as known from the surround sound becomes less important, since they may already be experienced as being located somewhere in the background. The shift from stereo to immersive 3D audio creates much more space, even to a point where there may be too much space. It has been surprisingly found that, if not all spatial gaps are filled with pieces of sound, the pieces of sound no longer seem to be working together to create one whole piece of music. Instead, a listener would typically experience this as standalone pieces of sound divided in the area surrounding the listener.

To solve these issues, the present invention provides 3D mixing tools which have the ability to place each piece of sound in a room as an object. Current 3D mixing tools provide a 3D soundscape software in which objects may be placed. The position of the object is subsequently translated to multiple outputs, typically represented by a loudspeaker. The translation is performed by a predefined algorithm. The 3D mixing tools according to the invention can also dynamically widen or narrow the width of the object; and as a result define how many speakers or sound sources will produce this particular sound coming from the object to fill up the entire space. By changing the dimensions of the object with the 3D mixing tool, it is possible to fill up the available space by closing the spatial gaps and to allow all the different objects to work together. In normal circumstances, such 3D mixing tools work well. A listener will find themselves emerged inside the sound which surrounds them. As mentioned before, the benefit of such a 3D environment and a 3D sound setup, is that it is possible to create the illusion that sound is moving. Typically, this is done by enhancing or decreasing the volume of a particular sound object, as can be done with a 2D dynamic compressor or dynamic expander. If one wished to simulate that a sound is moving from left to right, it may start off with a high volume of the sound object on the left side, decreasing it over time, while allowing the sound object to increase in volume on the right side. By raising and lowering the volume of the particular sound object, this will enhance or decrease the focus of a listener to this sound. Although this will have a great impact on how a listener will experience the sound, it may also have the downside that an increase in volume of a sound object may bring the total value of produced dB over an allowed limit, and it is thus not always acceptable and can in fact cause hearing damage. In addition, increasing the volume will have a direct impact on the energy consumption of the sound system. Therefore, it is necessary to establish a different kind of enhancement of the focus of a listener which will no longer increase the dB level or have an impact on the energy usage. Known 3D mixing tools may place each piece of sound in the room as objects. These 3D mixing tools are able to set a fixed wide or narrow width of the object to close any of the spatial gaps. This function is called the “spread” of an audio object. However, instead of using a static, unchanging spread for each object, the present invention provides in spatial adjustment, which can act in real-time in cooperation with the dynamic properties.

Therefore, a spatial adjuster such as a spatial compressor may be used, which is able to narrow the spread of a sound object, for example when reaching a predefined threshold. Alternatively or in combination, a spatial expander may be used, which is able to broaden or widen the spread of a sound object, for example when reaching a predefined threshold. This way, when, e.g., an artist raises their level for a moment to grab the focus of the audience, the 3D focus will follow the dynamic creative decision. So, when a group of artists play a quiet song, the audio object will blend together nicely in the 3D immersive mix. When one instrument or artist needs more focus when raising their level or by playing louder, the width of the audio object may be narrowed, thus resulting in a more focused position in the 3D immersive mix.

Similarly, a spatial expander may be used to widen the spread or width of the sound object. When mixing a piece of music which is too dynamic, instead of using the dynamic range compressors of the prior art, the present invention provides the use of a spatial expander. This spatial expander will work in the opposite direction of a spatial compressor. For example, when a mix is set and the different audio objects are too dynamic and incohesive, it is possible to widen the spread of the audio objects when a predefined threshold is reached by using spatial expanders on the audio objects. This would have the effect that, when an audio object is too focused in the mix, it would be spread and glued in the mix to work together with the other objects. Additionally, a combination is possible where spatial compression can be used on one or more objects, while spatial expansion is used on other audio object(s).

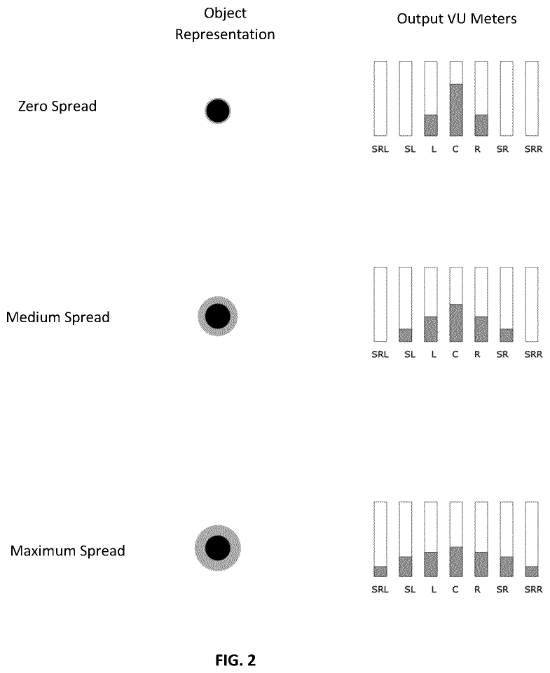

In FIG. 2, the effect of narrowing or broadening (or widening) the spread of an audio object is illustrated. This example holds when the object is placed in the virtual centre of the soundscape. With zero spread the output will only be the centre speaker. When there is zero spread of an audio object, the highest output of the VU meter will be in the centre (C), with some output left (L) and right (R) from the centre C. Typically, the C output will be in the range of 50-90%, preferably in the range of 60-80%, preferably 70%. The range of the spread is typically 0 to 100 percent. Mostly the range will be around 30%. In some exceptions it will be 100%. The Land R output will typically be in the range of 25-5%, preferably in the range of 20-10%, preferably 15%. With the zero spread there is normally no output in the SL, SRL, SR, or SRR VU meters. This will have the effect that the focus of the sound object is enhanced, since the sound object will come across more as a focal sound object. As used herein, the terms SL, SR, SRL, and SRR refer to the channels of a stereo audio system:
SL (Stereo Left) and SR (Stereo Right) refer to the left and right channels of a stereo audio system; and,
SRL (Stereo Return Left) and SRR (Stereo Return Right) refer to the left and right return channels in a sound reinforcement system, typically used for monitoring or for routing signals to and from other equipment.

These terms are used to identify and distinguish between the different channels of a stereo audio system, ensuring that the proper audio signals are being sent to and received from the correct locations.

When the spread of a sound object is widened to a medium spread, the level of the output of the VU meter in the C will be lowered, and spread more to the sides. As can be seen from the graphical representation in FIG. 2, the C output will be less than in the zero spread, and typically in the range of 40-60%, preferably 45-55%, preferably 50%. The numerical ranges are not per se important. The spread works by a predefined algorithm (for example Vector Based Amplitude Panning), which defines the output representation of a certain spread percentage. Also the Land R output will be less than in the zero spread, typically in the range of 25-20%, preferably 20%. With a medium spread, there will be an output in the SL and SR VU meters and the output will typically be in the range of 5-15%, preferably 5%. When the spread of a sound object is set to a medium spread, it will typically have the effect that the sound object is still detected as being in the foreground, but is less pronounced compared to a sound object with zero spread.

When the spread of a sound object is widened to a maximum spread, the level of the output of the VU meter in the C will be lowered even further, and spread even more to the sides, also providing an output in the SRL and SRR VU meters. As again can be seen from the graphical representation in FIG. 2, the C output will now be in the range of 20-40%, preferably 30%. The L and R output will typically be in the range of 20-15%, preferably 15%. The SL and SR output will typically be in the range of 5-15%, preferably 10%, and the SRL and SRR output will typically be in the range of 10-2%, preferably 5%. A sound object having a maximum spread will be experienced by a listener as being more in the background, while the focus of the listener will be automatically drawn to a sound object which has a medium or zero spread.

In some embodiments, the spread of additional objects may be adapted as well. The adjustment may be triggered by the same threshold as the first object, or by a different threshold, for example a threshold of the corresponding additional object.

Therefore, in some preferred embodiments, the method further comprises the steps of:
adjusting the spread of one or more additional objects in the 3D environment; preferably when the threshold level of the dynamic property of the first object is reached or exceeded.

In some preferred embodiments, the method further comprises the steps of:
setting a threshold level for a dynamic property of one or more additional objects; and,
adjusting the spread of the one or more additional objects in the 3D environment; preferably when the threshold level of the dynamic property of the corresponding object is reached or exceeded.

In some preferred embodiments, the step of adjusting the spread of the first object (and/or of the one or more additional objects) comprises narrowing the spread of said object in the 3D environment. By doing so, there will be more emphasis on the first object (and/or on the one or more additional objects) which were adjusted in the 3D environment. This step is referred to as spatial compression.

In some preferred embodiments, the step of adjusting the spread of the first object (and/or of the one or more additional objects) comprises widening the spread of said object in the 3D environment. By doing so, there will be less emphasis on the first object (and/or on the one or more additional objects) which were adjusted in the 3D environment. This step is referred to as spatial expansion.

The adjustment of the spread of a first sound object may result in adjusting the spread of a single second sound object in the opposite direction. Alternatively, the adjustment of the spread of a first sound object may result in adjusting the spread of more than one additional sound objects in the opposite direction. As a further alternative, adjusting the spread of a first and a second sound object in one direction may result in adjusting a third sound object in the opposite direction. As another further alternative, adjusting a combination of multiple sound objects in one direction may result in adjusting another combination of multiple sound objects in the opposite direction.

In some preferred embodiments, narrowing the spread of the first object will correspond to widening the spread of one or more additional objects. In some preferred embodiments, widening the spread of the first object will correspond to narrowing the spread of one or more additional objects.

In some preferred embodiments, the absolute amount of adjustment to the spread of a first object correspond to the absolute amount of adjustment to the spread of at least one additional object. In some preferred embodiments, the relative amount of adjustment to the spread of a first object correspond to the relative amount of adjustment to the spread of at least one additional object.

In some preferred embodiments, the step of adjusting the spread is performed gradually. In some preferred embodiments, the step of adjusting the spread starts gradually. A time period in which the spread is gradually modified at the start is herein referred to as the “attack zone”. The attack zone is the initial portion where the spread is altered from its original width to its modified (or desired) width.

In some preferred embodiments, the step of adjusting the spread starts at the start of the attack zone. In some preferred embodiments, the step of adjusting the spread ends gradually. A time period in which the spread is gradually modified to its original state is herein referred to as the “release zone”. The release zone is the end portion where the spread is altered from its modified (or desired) width to its original width.

The terms “attack zone” and “release zone” are often used in reference to audio compression and dynamic range processing, where the attack and release settings determine how quickly the gain of the sound is reduced or increased in response to the audio signal. In this invention, however, the attack zone and release zone refer to the change of width of the spread instead of the change in level of gain.

In some preferred embodiments, the step of adjusting the spread ends at the end of the release zone. In some preferred embodiments, the spread is kept constant over a specific time period. A time period in which the spread is modified to a constant value is herein referred to as the “hold zone”. In some preferred embodiments, the step of adjusting the spread comprises a hold zone.

In some preferred embodiments, the step of adjusting the spread only takes place as long as the threshold level of the dynamic property of the object is reached or exceeded. In some preferred embodiments, the step of adjusting the spread comprises the steps of:
once the threshold value is reached or exceeded, adjusting the spread in a first direction to widen or narrow the spread to a desired value;
as long as the threshold value is reached or exceeded, holding the spread at the desired value; and,
once the threshold value is no longer reached nor exceeded, adjusting the spread to the original value.

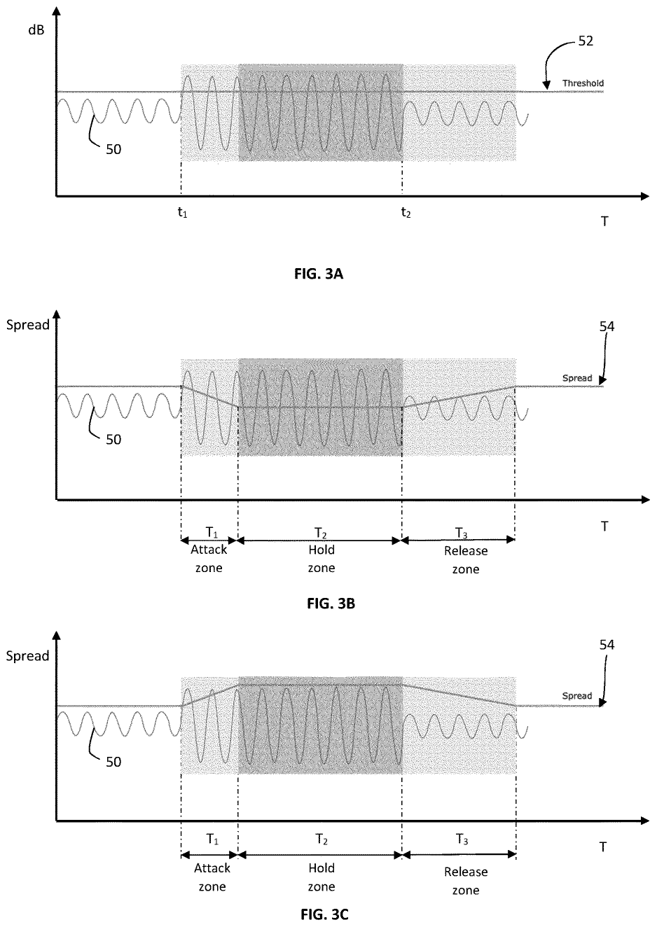

Looking at FIG. 3, a similar representation is given as in FIG. 1, where FIG. 3A corresponds to FIG. 1A. In FIG. 3A, a dynamic property, such as the gain, of a sound object 50 is represented over time. As can be seen, the dynamic property of the sound object 50 will reach or exceed the threshold value 52 between time t₁ and time t₂. Typically, in a 3D sound experience, such an increase of decibel can occur when a vocal sound object is increased in intensity, e.g., when a singer starts to sing. Very similar to a dynamic compressor, a spatial compressor 60 according to the invention will now be able to limit the spread of the sound object 50, but opposite to when limiting the gain of the sound object 10 of FIG. 1, the focus will now be increased due to the fact that the spread of the sound object 50 will be narrowed from, e.g., a medium spread as represented in FIG. 2 to a low or zero spread. On the other hand, with a spatial expander, it will be possible to widen the spread of the sound object 50 so that the focus on this object will be decreased by widening the spread from, e.g., a medium spread to a high or maximum spread.

Very similar to the attack, hold, and release zones of the audio gain illustrated in FIG. 1, comparable attack, hold, and release zones may be applied for changing the spread of a sound object 50. In relation to spatial adjustment, the attack zone T₁ is a time value, typically defined in milliseconds, which determines the time the process requires to obtain the desired spread. The release zone T₃ on the other hand is a value in milliseconds which defines the time it takes for the width to return to its original state once the level of the object 50 returns back below the threshold value 52. The attack zone may range from at least 0 ms to at most 1 s, for example from at least 10 ms to at most 100 ms. The release zone may range from at least 10 ms to at most 2 s, for example from at least 20 ms to at most 1 s, for example from at least 50 ms to at most 200 ms. In the example as shown in FIG. 3B, the effect of spatial compression by a spatial compressor 60 is shown. Once the sound object 50 reaches the threshold value 52 at time t₁, the spatial compressor 50 will start to adjust the spread 54 over a first period of time T₁ from a wider spread to a smaller spread. Once it reaches the smaller spread, it will maintain this level of spread 54 for a period of time T₂ until the sound object 50 stops to exceed the threshold value 52 at the time t₂. During a final release period T₃, the spread 54 of the sound object 50 will now be allowed to widen again to its original level.

Likewise, the example of FIG. 3C shows the effect of spatial expansion by a spatial expander. Again, once the sound object 50 reaches the threshold value 52 at time t₁, the spatial expander will start to adjust the spread 54 over a first period of time T₁ from a specific spread to a wider spread. Once it reaches this wider spread, it will maintain this level of spread 54 for a period of time T₂, until the sound object 50 stops to exceed the threshold value 52 at the time t₂. During a final release period T₃, the spread 54 of the sound object 50 will now be allowed to narrow again to its original level.

In some embodiments, the spread is adjusted or controlled using a feedback adjuster (feedback compressor and/or feedback expander). A feedback adjuster uses an algorithm that adjusts the compression/expansion amount in real-time based on the input signal. It continuously monitors the input level and dynamically changes the compression/expansion ratio. This allows it to react to changes in the input signal and maintain a desired level of compression/expansion, producing a more consistent and controlled output.

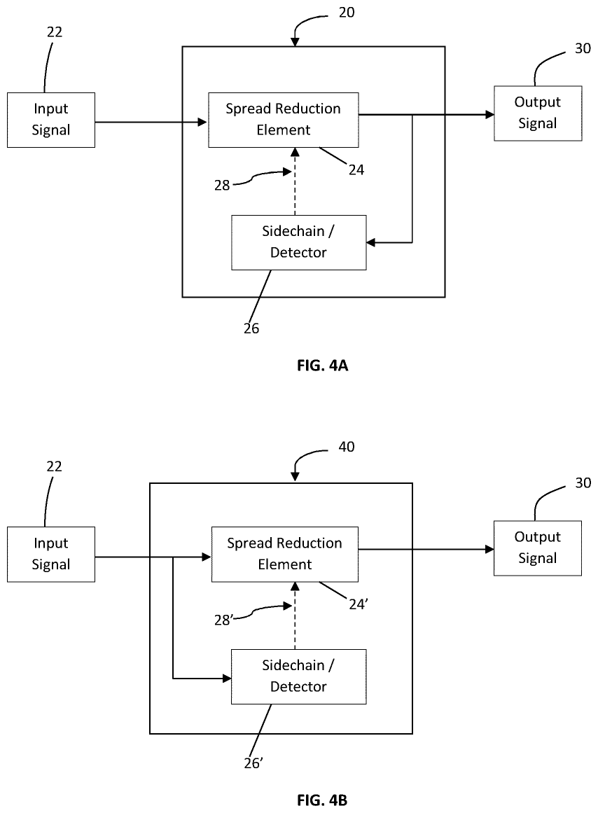

FIG. 4A shows a schematic representation of a feedback spread compressor 20 according to an embodiment of the invention. On one side of the compressor 20, an input signal 22 is fed to the compressor. When the input signal leaves the spread reduction element 24, it is diverted to a sidechain 26. This sidechain 26 is able to detect if the threshold value 12 is reached or exceeded. If this is the case, a sidechain control signal 28 is sent to the spread reduction element 24 which will narrow the spread of the input signal 22. The spread of the output signal 30 now leaving the feedback compressor 20 is narrowed for as long as the sidechain 26 detects that the threshold value 12 is reached or exceeded. The speed at which a reduction in spread 14 of the output signal 30 is reached, depends heavily on the duration of the attack zone T₁ and on the ratio of the attenuation. The higher the ratio of the attenuation and the shorter the duration of the attack zone T₁, the faster the narrowing of the signal will occur.

In some embodiments, the spread is adjusted or controlled using a feedforward adjuster (feedforward compressor and/or feedforward expander). A feedforward adjuster works by using an input signal to predict the spread adjustment needed, and then applying that spread adjustment directly to the audio signal. Unlike a feedback adjuster, which uses an error signal to determine spread adjustment, a feedforward adjuster uses the input signal to directly control the spread adjustment. This approach results in a faster and more accurate adjustment, as the spread adjustment is applied before any other processing occurs. It is particularly advantageous in situations where a highly responsive adjustment is required, such as live sound and broadcast applications.

FIG. 4B shows a schematic representation of a feedforward spread compressor 40 according to an embodiment of the invention, whereby the input signal 22′ is immediately diverted to the sidechain 26′ to detect if the threshold value 12 is reached or exceeded. If this is not the case, the input signal 22′ will correspond to the output signal 30′. However, if the threshold value 12 is reached or exceeded, a sidechain control signal 28′ will be sent to the spread reduction element 24′, which will again reduce the spread of the input signal 22′, and will lower the spread of the final output signal 30′. The benefit of such a feedforward compressor 40 is that a faster adaptation of the spread is possible.

Likewise, a spread expander can be used which will work in a similar but opposite way, to increase the audio spread in order to diffuse the sound object.

In some embodiments, the spread adjustment is combined with other adjustments of other dynamic properties, such as classical dynamic compression or expansion of the gain. Narrowing of the spread may be combined with compression of other dynamic properties such as the gain. Narrowing of the spread may be combined with expansion of other dynamic properties such as the gain. Broadening of the spread may be combined with compression of other dynamic properties such as the gain. Broadening of the spread may be combined with expansion of other dynamic properties such as the gain. Most preferably, widening the spread is combined with reducing the gain, and vice versa.

Therefore, in some preferred embodiments, the method further comprises the step of:
adjusting an additional dynamic property (other than spread) of the first object and/or the one or more additional objects in the 3D environment when the threshold level of the dynamic property of the first object is reached or exceeded. In some preferred embodiments, the method further comprises the step of:
adjusting an additional dynamic property (other than spread) of the first object and/or the one or more additional objects in the 3D environment when the threshold level of the dynamic property of the one or more additional objects is reached or exceeded.

This additional dynamic property is preferably selected individually from gain, reverb, or position; or selected from the combinations (gain, reverb), (reverb, position), or (position, gain); or a combination of all three (gain, reverb, position); preferably at least gain.

Therefore, in some preferred embodiments, the method further comprises the step of:
adjusting the gain of the first object and/or the one or more additional objects in the 3D environment when the threshold level of the dynamic property of the first object is reached or exceeded.

Therefore, in some preferred embodiments, the method further comprises the step of:
adjusting the gain of the first object and/or the one or more additional objects in the 3D environment when the threshold level of the dynamic property of the one or more additional objects is reached or exceeded.

Preferably, the thresholds for gain and spread would be identical. In some embodiments, the thresholds for gain and spread could be adjusted separately.

In some embodiments, the adaptation of the spread is related to the gain of a specified output of the multichannel format. For example, when the spatial compressor widens the spread of an object, the object's LFE output send is compressed in level in relation to the spread widening.

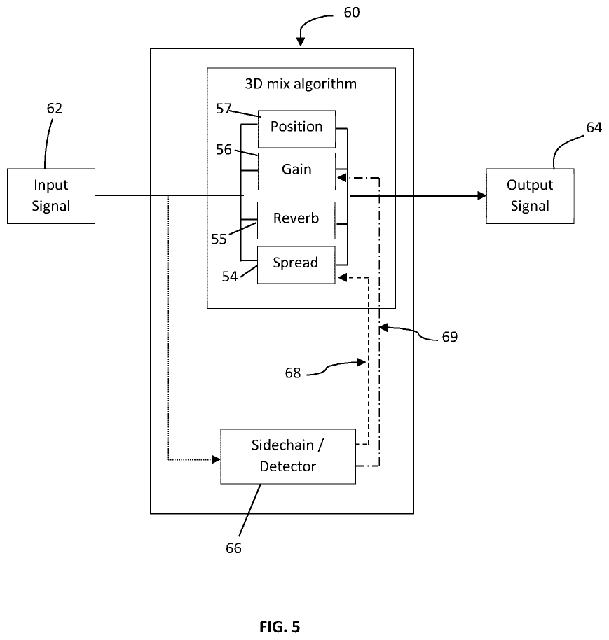

In FIG. 5, a spatial adjuster 60 according to an embodiment of the invention is schematically represented. Although the general outline is similar to the spatial adjuster 20 of FIG. 4, the spatial adjuster 60 is capable of adjusting more than just the spread. Besides the spread 54 of a sound object, the spatial adjuster 60 is for example also configured to adjust the gain 56 of the sound object in the 3D environment (like a classic compressor/expander). Alternatively or in combination, the spatial adjuster 60 is also configured to adjust the reverb 55 of a sound object and/or the position 57 of the sound object in the 3D environment. This could, for example, be performed by controlling the amount of signal that is sent from the object to the reverb processor. By raising the level, the amount of reverb would raise linearly. For example, when the spatial adjuster 60 is used as a spatial compressor 60, the input signal 62 is immediately diverted to a sidechain or detector 66 to detect if the threshold value 52 is reached or exceeded. If this is not the case, the input signal 62 will correspond to the output signal 64. However, if the threshold value 52 is reached or exceeded, this will be detected by the detector 66 and a separate sidechain control signal 68 will be sent to the spread adjustment element 54, which will reduce the spread of the sound object in the 3D environment, enhancing the focus on this sound object.

Optionally, a further additional signal 69 can also be given by the sidechain controls or detector 66 to the gain adjustment element 56, when the same or a different threshold value was reached or exceeded. By doing so, the gain of the input signal 62 can also be adjusted, i.e. being raised or lowered depending on the use of the spatial adjuster as a compressor or as an expander, to increase or decrease the volume level of the audio object in the 3D mix. By combining the adjustment of the spread 54 and the adjustment of the gain 56, e.g., spatially narrowing the spread of the audio signal by the spatial compressor and simultaneously allowing the volume to rise as to emphasise even more the effect, this achieves a more creative or optimally mixed result. Further optionally, also the position and the reverb of the input signal 62 may be adjusted by likewise sending an further signal to the position adjustment element 57 and/or the reverb adjustment element 55.

If multiple audio objects are sent to the spatial adjuster 60, it is possible to amend some or all audio objects on the basis of changes made to the first audio object 50. When, e.g., the spread of the first audio object 50 is changed from a medium spread to a zero spread, at least one of the adjacent audio objects may be amended accordingly in the opposite direction, so from a medium spread to a maximum spread. When the spread of only one audio object is narrowed, as to put more emphasis on the audio object, and the spread of, e.g., two adjacent audio objects are widened, a mix can be made between how much the first adjacent object is widened and how much the second adjacent object is widened, such that when the total sum of the widened spreads equals the narrowed spread such that no spatial gaps are created when adjusting the spread of one of the sound objects.

By using the sidechain controls on all audio objects and feeding it a, e.g., mono sum of all object signals, a spatial bus compression could be achieved. By doing so, all audio objects may, for example, be enhanced due to the fact that the spread of all audio objects are narrowed. The spread of all audio objects may be narrowed or widened this way, depending on the desired effect. For spatial bus compression, the typical situation would be widening the spread of the objects. Likewise, when working with spatial bus expansion, one could glue a piece of music together and have the same result as would be the case with a stereo bus compressor.

When working with audio objects that carry full range signals or a number of low end signals (Lows), it may be that using a single spatial adjuster will not work in an optimal manner, resulting in a spread of these audio objects which is too wide. On the other hand, for the Mids and Highs, the widening of the spread may not be enough.

A variation of the spatial adjuster, either it being a spatial compressor or a spatial expander, is a multiband spatial compressor or multiband spatial expander. Such a multiband spatial expander may work in multiple separate frequency bands (for example three frequency bands, such as Lows, Mids, and Highs), each of them working in an adjustable frequency range. Each frequency band may have their own set of parameters, allowing to keep the spread of the Lows narrow, while allowing the spread of the Mids and Highs to be widened, or vice versa.

According to a second aspect, the invention relates to a mixing tool for processing audio signals of sound objects in a 3D environment. The mixing tool is preferably configured to perform the method according to the first aspect, and (preferred) embodiments thereof. In some preferred embodiments, the method according to the first aspect, and (preferred) embodiments thereof, is performed by using a mixing tool according to the second aspect, and (preferred) embodiments thereof. (Preferred) embodiments of the first aspect are also (preferred) embodiments of the second aspect, and vice versa.

The mixing tool preferably comprises:

an input channel for receiving an input signal (62);
an output channel for transmitting an output signal (30); and,
a detector (66) configured for receiving the input signal (62), for determining whether the input signal (62) is equal to or greater than a threshold value (52), and for sending a control signal (68) when the threshold value (52) is reached or exceeded.

The mixing tool preferably further comprises a spatial adjuster (60), configured for receiving the input signal (62) and adjusting the spread of the input signal (62) on the basis of the control signal sent by the detector (66), to form an output signal (30).

In some preferred embodiments, a second control signal (69) is sent out to adjust an additional dynamic property of the input signal (62) when the threshold value (52) is reached or exceeded; preferably wherein the additional dynamic property is selected from gain, position, reverb, and/or combinations thereof; preferably wherein the additional dynamic property is gain.

In some preferred embodiments, the spatial adjuster (60) comprises a spatial compressor to narrow the spread of the input signal (62) when the threshold value (52) is reached or exceeded; and/or the spatial adjuster (60) comprises a spatial expander to widen the spread of the input signal (62) when the threshold value (52) is reached or exceeded.

In some preferred embodiments, the mixing tool according to the second aspect, and (preferred) embodiments thereof, is configured to perform the method according to the first aspect, and (preferred) embodiments thereof.

According to a third aspect, the invention relates to use of the method according to the first aspect, and (preferred) embodiments thereof, and/or of the mixing tool according to the second aspect, and (preferred) embodiments thereof, in a live setting. The present methods and mixing tool of the present invention are particularly suitable for real-time processing, and are therefore particularly suitable for use in a live setting.

The invention may be computer-implemented for studio mixing purposes. In this case, it could, for example, be provided as a plugin (VST) for a DAW system, or could form a part of a DAW system. In the live or broadcast sector, it could be implemented as a part of the processing in a live immersive mixing desk.

In some preferred embodiments, the method performs the adjustments in real-time. In some preferred embodiments, the mixing tool is configured to be operated in real-time. In the context of computer processing, a method that is performed “in real-time” refers to a process that occurs as fast as it is needed, with minimal or no delay. In order for an audio process to be considered real-time, it must be able to complete within a predetermined timeframe, known as the “latency.” The latency of a real-time process is typically measured in milliseconds or microseconds, and it must be small enough to meet the requirements of the application. For example, in a real-time audio processing system, the latency must be small enough to ensure that the processed audio is played back in sync with the original audio, without any noticeable delay. Preferably the latency is at most 20 ms, for example at most 10 ms. When working live, the latency is preferably at most 2 ms, more preferably at most 1 ms.

Real-time processing requires a combination of fast hardware and efficient software algorithms in order to meet the strict latency requirements. The present invention has the advantage that the method is efficient enough to be performed in real-time.

In some embodiments, the method is a computer-implemented method. In some embodiments, one or more steps of the method are performed by a computer. In some embodiments, all steps of the method are performed by a computer.

The invention also relates to a system or device, such as a data processing apparatus, comprising means for carrying out one or more steps, for example all steps, of the method according to the first aspect of the invention, and (preferred) embodiments thereof. The system or device may comprise different hardware and/or software aspects to provide the functionalities as illustrated. For example, the system or device may comprise a computer, a computing system, or a processor, e.g., a general-purpose computing platform specifically programmed, e.g., by a suitable executable code, for implementing all or some elements described herein. In embodiments, the system or device may operate as a standalone device or may be connected, e.g., networked, to other machines in a networked deployment.

The invention also relates to a computer program product directly loadable into the internal memory of a computer, or a computer program product stored on a computer readable medium, or a combination of such computer programs or computer program products, configured for performing a computer-implemented method according to the first aspect of the invention, and (preferred) embodiments thereof.

The invention also relates to a computer program product comprising instructions which, when the program is executed by a computer, cause the computer to carry out one or more steps, for example all steps, of the method according to the first aspect of the invention, and (preferred) embodiments thereof. The invention also relates to a computer-readable medium comprising instructions which, when executed by a computer, cause the computer to carry out one or more steps, for example all steps, of the method according to the first aspect of the invention, and (preferred) embodiments thereof.

1. A computer-implemented audio signal processing method for regulating the emphasis on sound objects in a 3D environment, the sound objects being spaced in the 3D environment, said method comprising:
setting a threshold level for a gain of a first object; and,
adjusting a spread of the first object in the 3D environment when the threshold level of the gain of the first object is reached or exceeded.

2. The method according to claim 1, wherein the method further comprises:
setting a threshold level for a dynamic property of one or more additional objects; and,
adjusting a spread of the one or more additional objects in the 3D environment when the threshold level of the dynamic property of the corresponding object is reached or exceeded.

3. The method according to claim 1, wherein adjusting the spread of the first or the one or more additional objects, or both, comprises narrowing the spread of said object in the 3D environment.

4. The method according to claim 1, wherein adjusting the spread of the first or the one or more additional objects, or both, comprises widening the spread of said object in the 3D environment.

5. The method according to claim 3, wherein narrowing the spread of the first object corresponds to widening the spread of the one or more additional objects, or vice versa.

6. The method according to claim 3, wherein narrowing the spread of the first object is defined by a ratio between an amount of level the gain generates above the threshold level.

7. The method according to claim 1, wherein the method further comprises:
adjusting the gain of the first object or the one or more additional objects, or both, in the 3D environment when the threshold level of the gain of the first object is reached or exceeded or when the threshold level of the gain of the one or more additional objects is reached or exceeded.

8. The method according to claim 1, wherein adjusting of the spread starts at a start of an attack zone.

9. The method according to claim 1, wherein adjusting the spread only takes place as long as the threshold level of the gain of the object is reached or exceeded.

10. The method according to claim 1, wherein adjusting the spread comprises:
once the threshold value is reached or exceeded, adjusting the spread in a first direction to widen or narrow the spread to a desired value;
as long as the threshold value is reached or exceeded, holding the spread at the desired value; and,
once the threshold value is no longer reached nor exceeded, adjusting the spread to the original value.

11. A mixing tool for processing audio signals of sound objects in a 3D environment, the mixing tool comprising:
an input channel for receiving an input signal;
an output channel for transmitting an output signal;
a detector configured for receiving the input signal, for determining whether the input signal is equal to or greater than a threshold value of a gain, and for sending a control signal when the threshold value is reached or exceeded; and
a spatial adjuster, configured for receiving the input signal and adjusting a spread of the input signal on the basis of the control signal sent by the detector, to form an output signal .

12. The mixing tool according to claim 11, wherein a second control signal is sent out to adjust an additional dynamic property of the input signal when the threshold value is reached or exceeded.

13. The mixing tool according to claim 11, wherein the spatial adjuster comprises a spatial compressor to narrow the spread of the input signal when the threshold value is reached or exceeded; or wherein the spatial adjuster comprises a spatial expander to widen the spread of the input signal when the threshold value is reached or exceeded.

14. The mixing tool according to claim 11, configured to perform a computer-implemented audio signal processing method for regulating the emphasis on sound objects in a 3D environment, the sound objects being spaced in the 3D environment, said method comprising:
setting a threshold level for a gain of a first object; and,
adjusting a spread of the first object in the 3D environment when the threshold level of the gain of the first object is reached or exceeded.

15. A method of using the mixing tool according to claim 11, in a live setting.

16. The method according to claim 5, wherein an absolute or relative amount of adjustment to the spread of the first object corresponds to an absolute or relative amount of adjustment to a spread of at least one additional object.

17. The method according to claim 4, wherein widening the spread of the first object is defined by a ratio between an amount of level the gain generates above the threshold level.

18. The method according to claim 6, wherein the amount of level the gain generates above the threshold level is expressed in decibels (dB).

19. The method according to claim 6, wherein the amount of level the gain generates above the threshold level is expressed in percentage in relation to an amount of spread.

20. The mixing tool according to claim 12, wherein the additional dynamic property is selected from gain, position, reverb, or combinations thereof.
